(19) United States
(12) Patent Application Publication
(10) Pub. No.: US 2002/0161786 A1
(43) Pub. Date: Oct. 31, 2002

(54) Method and system for rapidly responding to customer inquires

(76) Inventors: Frank Mangan, Vernon Hills, IL (US); Russell Walker, Vernon Hills, IL (US); Christina Hartman, Vernon Hills, IL (US)

Correspondence Address: ARMSTRONG,WESTERMAN & HATTORI, LLP, 1725 K STREET, NW., SUITE 1000, WASHINGTON, DC, 20006, US

(21) Appl. No.: 09/844,436

(22) Filed: Apr. 30, 2001

(51) Int. Cl. G06F 7/00

(52) U.S. Cl. 707/200

(57) ABSTRACT

A computer based method, in a system wherein a plurality of predetermined users, each having a predetermined sales region and each having access to a secured portion of a main server, for enhancing each user's ability to rapidly respond to internet based inquiries regarding construction machinery and earth moving equipment, includes the steps of receiving, at an internet web site of the main server, a plurality of customer inquiries, the inquiries each including information about the customer, opening an inquiry file on each received, unanswered inquiry, each inquiry file including the customer information, and sorting each inquiry file into one of a plurality of predetermined regions corresponding to sales regions of the users, wherein the sorting is based upon the customer information. Furthermore, the method also includes providing an individual user, who has accessed the secured portion of the main server, with a list of all open inquiry files with unanswered inquiries in that user's region, upon the user's selection of a single inquiry file from the list, providing the user with the selected inquiry file, including the customer information, so that the user may contact the customer regarding the customer's inquiry. After the user has initial contact with the customer, the user is enabled to input into the secured portion of the main server results of the initial contact, and subsequently, the user is enabled to input final results of subsequent contact with the customer. The inquiry file is then closed after receiving input of the final results.

### BACKGROUND OF THE INVENTION

1. Field of the Invention

This invention is directed to a method and system for rapidly responding to customer inquiries in the field of construction machinery and earth moving equipment. More specifically, the instant invention is directed to a system and method and system which provides for a structured, Internet based system for rapidly responding to customer inquiries.

2. Description of the Related Art

In the past, in the field of construction machinery and earth moving equipment, answers to inquiries from customers (whether potential or existing customers) has been haphazard at best. Before the advent of the internet, most inquiries from customers were received by the manufacturer by telephone or other methods of communication. Channeling such inquiries to the distributor in whose territory or region the customer resides has been difficult at best. To do so in a timely manner has been even more difficult.

In this age of increased competition, continual improvement of customer service is vital for a company to remain competitive. Furthermore, in view of the advent of the internet, many such inquiries which before may have come through the telephone or other methods of communication, now come through the internet. These inquiries include questions regarding line of products, specific prices for specific models, leasing questions, financing questions, etc. It is important to be able respond quickly to such inquiries in order to create a possible feeling in the customer. The instant invention, which will be described in more detail below, is intended to provide a method and system for rapidly responding to such customer inquiries.

### SUMMARY OF THE INVENTION

The method and system in accordance with the instant invention is intended to overcome the problems described above. It will improve the response time for answering internet based customer inquiries provided to a manufacturer. Most manufacturers today maintain their own web site for disseminating information to customers (existing and potential). Such web sites often will have the capability of receiving inquiries from customers. It is more economical and efficient to have such inquiries answered at a regional level by a distributor (or user) who is closer to the customer inquiring to the manufacturer. According to the instant invention, a method and system is provided to assist the distributor and manufacturer to share information to more rapidly answer these inquiries.

Each distributor can have the capability of accessing a secured extranet portion of the manufacturer's main server. By making this connection, the distributor may be able to share in the customer inquiries from customers in the distributor's region or territory. With this information, the distributor may make direct contact with the customer. The main server is able to solicit information about customer contacts and retain the records about such contacts. Customer inquiries can be sorted by inquiry category, such as new equipment, used equipment, rental equipment, attachments, product support or finance. Thus, answers to such customer inquiries can be accomplished more quickly and efficiently.

More specifically, a computer based method is provided in a system wherein a plurality of predetermined users, each having a predetermined sales region and each having access to a secured portion of a main server, for enhancing each user's ability to rapidly respond to internet based inquiries regarding construction machinery and earth moving equipment, includes the steps of receiving, at an internet web site of the main server, a plurality of customer inquiries, the inquiries each including information about the customer, and opening an inquiry file on each received, unanswered inquiry, each inquiry file including the customer information. Further, the method includes sorting each inquiry file into one of a plurality of predetermined regions corresponding to sales regions of the users, wherein the sorting is based upon the customer information, providing an individual user, who has accessed the secured portion of the main server, with a list of all open inquiry files with unanswered inquiries in that user's region, and upon the user's selection of a single inquiry file from the list, providing the user with said selected inquiry file, including the customer information, so that the user may contact the customer regarding the customer's inquiry. Additionally, the method includes, after the user has initial contact with the customer, enabling the user to input into the secured portion of the main server results of the initial contact, enabling the user to input final results of subsequent contact with the customer; and closing the inquiry file after receiving input of the final results.

The method further includes archiving the inquiry file after the closing step. Also, after input of results of the initial contact, providing the user with the list of remaining unanswered inquiries in open files, so that the user may make another selection. The customer information should include at least the name, address, telephone number and area of interest. Additionally, it may include facsimile number, E-mail address, and contact person. Preferably, the secured portion of the main server is an extranet web site accessible through the internet.

The step of enabling the user to input the final results includes providing the user with a selection of at least, purchased product or service listed in inquiry, rented product or service listed in inquiry, purchased other product or service, rented other product or service, decided not to purchase, and purchased competitor's product. Furthermore, the step of providing the individual user with a list of unanswered inquiries of the open files includes, identifying the user as one of the predetermined users upon the user's access to the secured portion of the main server, and preparing the list of unanswered inquiries based on customers located within the user's region. Once an initial contact is made between the user and customer and the user has input the results of the initial contact, an open inquiry file is designated as being answered.

### BRIEF DESCRIPTION OF THE DRAWINGS

FIG. 1 is a block diagram illustrating the relationship between different parties and their interconnections with regard to the instant invention;

FIG. 2 is a flow chart illustrating the method in accordance with the instant invention;

FIG. 3 is a screen illustrating a main screen including a summary of inquiries for a specific user;

FIG. 4 is a list of all unanswered customer inquiries for a particular user;

FIG. 5 is a list of “In Progress” inquiries for that particular user;

FIG. 6 is an open file for one particular customer inquiry including information provided by the customer;

FIG. 7 is a screen into which a user will input information regarding an initial contact with the customer;

FIG. 8 is a screen indicating confirmation of acceptance of initial contact information;

FIG. 9 is a screen illustrating basic customer information which may be called up when preparing to finally close the open file;

FIG. 10 is a screen illustrating more detailed information of the contact with the customer;

FIG. 11 is a screen illustrating a form for filling in a final result of customer contact;

FIG. 12 is a screen illustrating that the inquiry file has now been closed and archived;

FIG. 13 is a screen illustrating files that have been archived;

FIG. 14 is a detailed archive file based on FIG. 13;

FIG. 15 is a second screen illustrating more details of an archived inquiry;

FIG. 16 illustrates an invalid inquiry listing from the archives;

FIG. 17 illustrates more detail regarding the screen of FIG. 16;

FIG. 18 is a screen illustrating a more detailed invalid inquiry listing; and

FIG. 19 is a screen illustrating answers to frequently asked questions.

### DETAILED DESCRIPTION OF THE INVENTION

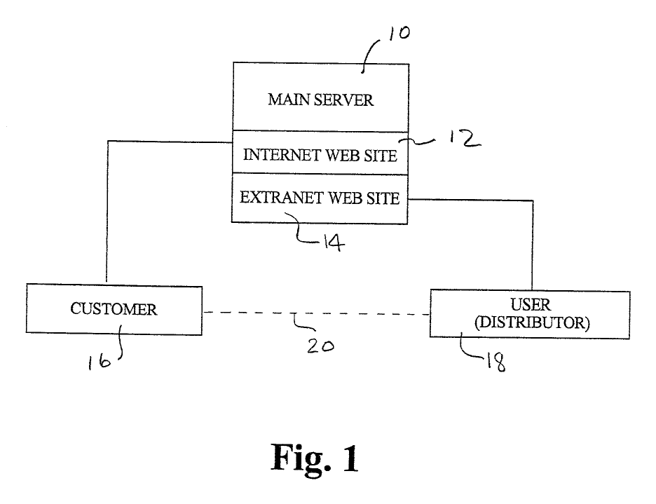

The method and system of the instant invention is intended to be used jointly by the manufacturer and its distributor. The manufacturer has numerous distributors for marketing the manufacturer's products. Generally, the instant invention applies to the field of construction machinery and earth moving equipment. As illustrated in FIG. 1, the manufacturer maintains a main server 10 which has an internet web site 12 and an extranet web site 14. An extranet web site is simply a secured web site accessible through the internet. A customer 16 can access internet web site 12 of the main server. A customer, as described in this application, may refer to an existing customer or a potential customer. Customer 16, upon obtaining access to internet web site 12, is then prompted to an inquiry screen where he may input his name, address, and other pertinent identification information, as well as what type of equipment or what type of information he is inquiring about. He may be inquiring about a specific model of construction machinery or he may be inquiring about financing options, and so forth. The user 18 (generally a distributor of the manufacturer's products), is authorized to access the extranet web site 14. User 18 may obtain information regarding an inquiry from the customer who is located in the territory of the distributor or user 18. Broken line 20 indicates a contact medium, such as telephone or facsimile through which the distributor or user makes direct contact with customer 16. Main server 10 carries out the method and system in accordance with the instant invention mainly through software and connections with the computer of the distributer and the customer computer by way of internet communications. Of course, such connections could be of many different types including direct connections, radio links, satellite links, and so forth. FIG. 1 indicates a single customer 16 which is able to access internet web site 12 of main server 10. However, of course, the customer 16 is intended to represent multiple customers which will be making inquiries of internet web site 12. In the same manner, user 18 is intended to represent one of a multiplicity of users or distributors, each having its own specific territory or region.

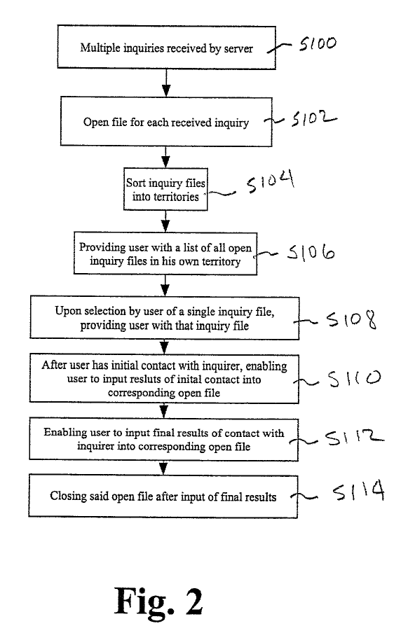

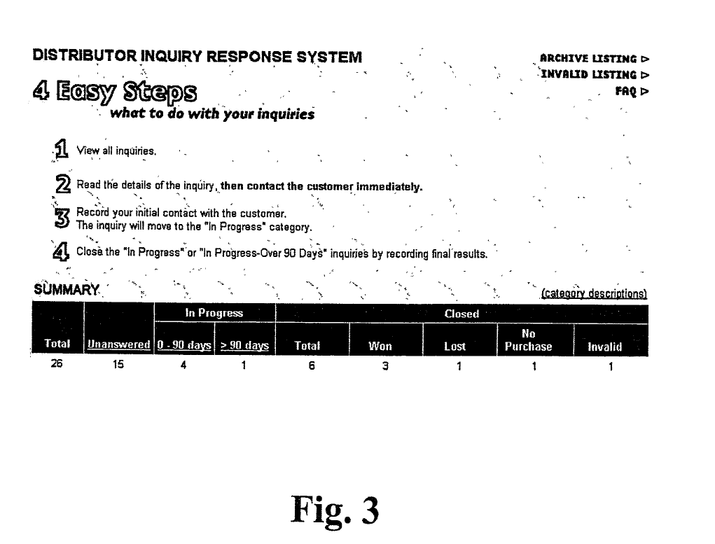

FIG. 2 is a flow chart illustrating the computer based method for improving response time by a user, to internet based customer inquiries. As described above, a user represents the distributor, and through the distributor's computer system, accesses the extranet web site 14 of main server 10, communicates therewith, and acts on those communications. The method illustrated in FIG. 2 will be described also in connection with the screens illustrated in FIGS. 3-19.

In FIG. 2, step S100 indicates that multiple customer inquiries are received by main server 10. Next, at step S102, a file is opened for each received customer inquiry. At step S104, main server 10 sorts the individual open inquiry files into predetermined territories or regions set up for each individual distributor (or user). Open inquiry files may also be sorted by inquiry category, described above.

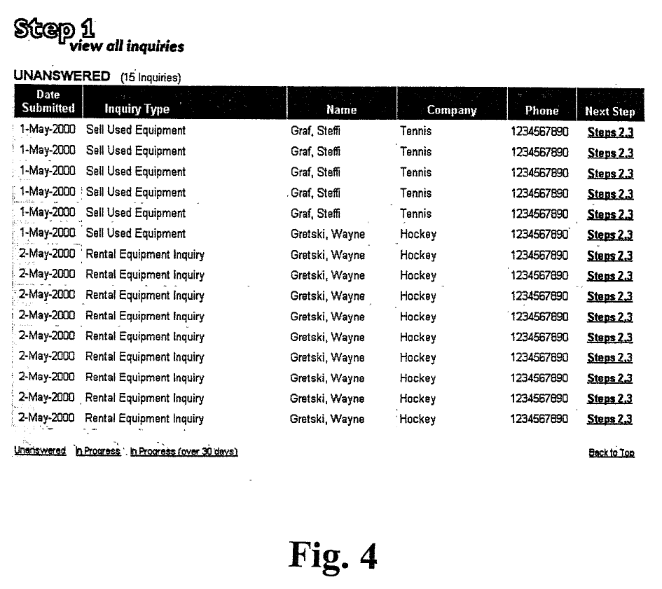

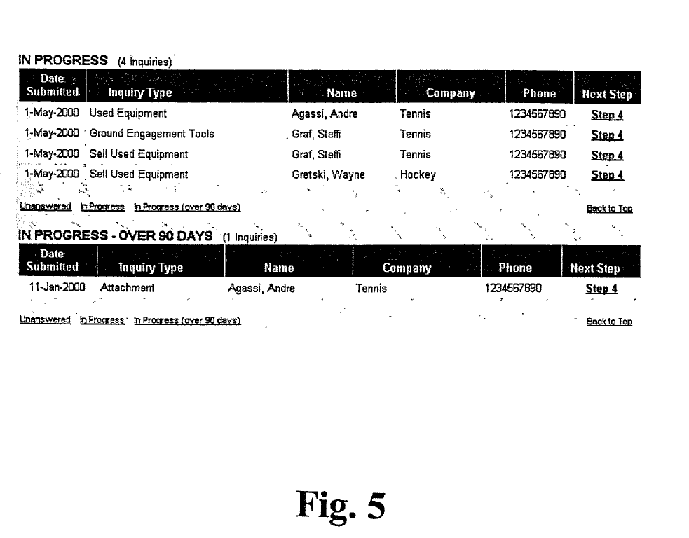

FIG. 3 illustrates a main screen which indicates 4 different steps for a user to proceed through in order to properly respond to an open inquiry. Also, a notification banner entitled “Summary” is provided at the bottom of the screen indicating the status of “unanswered”, “In Progress”, and “Closed” customer inquiries. If the user selects number 1, “view all inquiries” in FIG. 3, a list of all open inquiry files (or unanswered inquiries) from that user's own territory will be provided at step S106, and as illustrated in FIG. 4. As noted in FIG. 4, the fields indicate the date submitted, the inquiry type (such as selling used equipment, rental equipment inquiry, etc . . . ), the name, company and phone number of the company. An additional field is provided for what to do next. As illustrated in FIG. 4, the next step for each inquiry indicates “steps 2 and 3”. This, of course corresponds to steps 2 and 3 illustrated in FIG. 3. The list of open inquiry files of step S106, also includes the “In Progress” files as illustrated in FIG. 5. The “In Progress” files illustrated in the screen of FIG. 5 are organized into two groups. The first group, simply referred to as “In Progress” are those who are substantially 90 days or less in age. FIG. 5 illustrates 4 such inquiries, with fields similar to the fields of unanswered inquiries in FIG. 4. The second “In Progress” category in FIG. 5 is the “over 90 days” category. In that category there is only one inquiry illustrated in FIG. 5. This category, has the same fields as in FIG. 4. In considering FIGS. 4 and 5, the user has now accomplished step 1 (View All Inquiries) of FIG. 3.

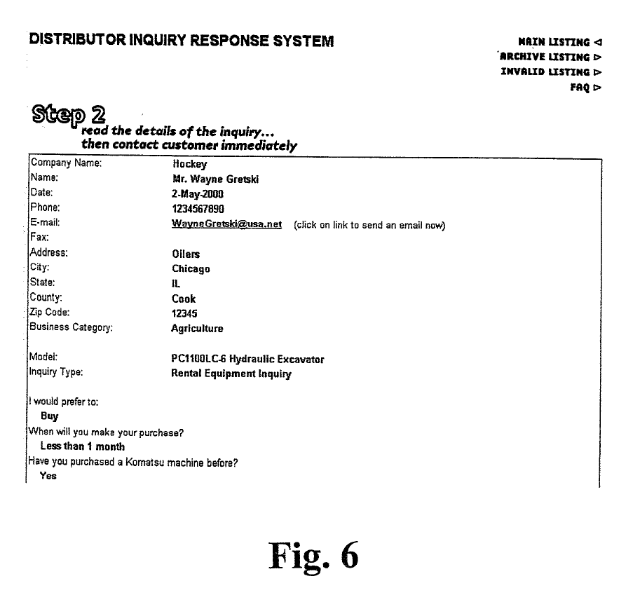

As indicated at step S108, upon the selection of a single unanswered inquiry file (although it is possible for the user to also select an “In Progress” file) that inquiry file is provided to the user. This inquiry file is illustrated in the screen of FIG. 6. It specifically provides for the company name, the name of the contact, as well as address, communication information, such as telephone, E-mail and fax, etc . . . A business category is provided which includes items such as agriculture, construction, mining, etc . . . Further, information is obtained, if possible, regarding the model type of machinery or equipment that the customer is interested in and the inquiry type, such as rental equipment inquiry new sales inquiry, etc . . . Additionally, other marketing information is solicited form the customer which is added to the inquiry file, such as buy or rental preference when the purchase is expected, etc . . . This illustrates step 2 of the 4 steps of FIG. 3. As illustrated, step 2 includes reading the details of the inquiry, and then contacting the customer immediately. It is up to the user to take the responsibility to make contact with the customer.

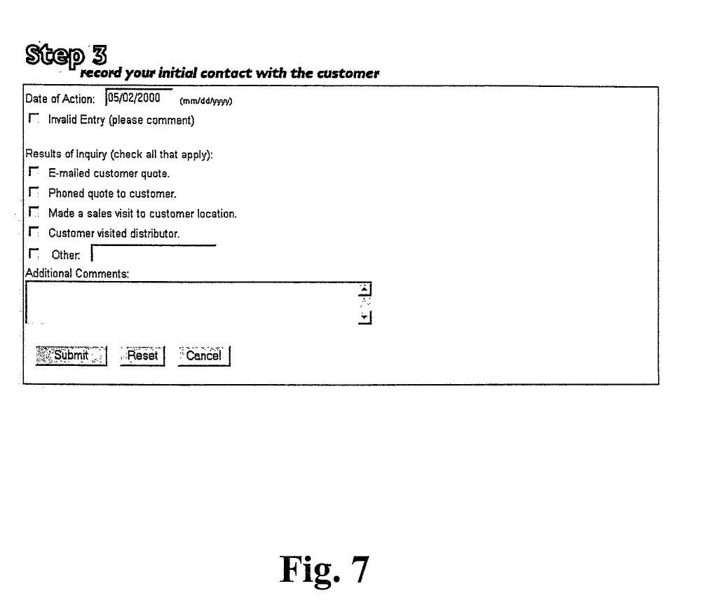

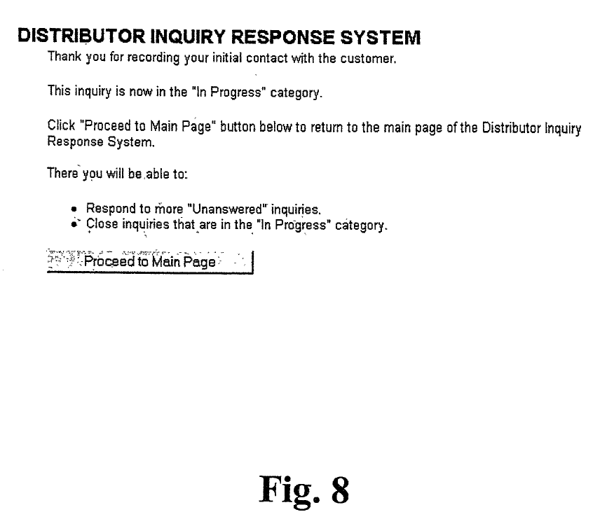

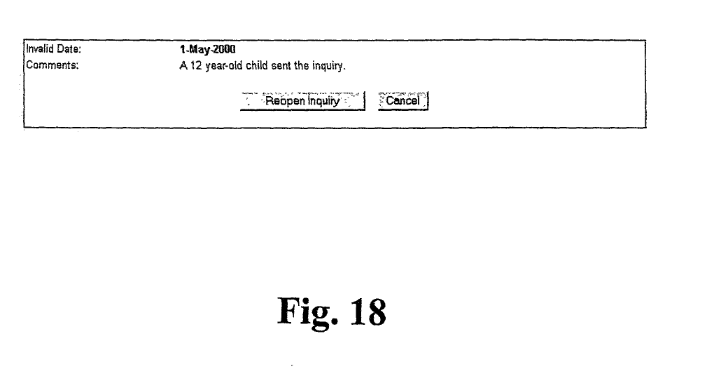

FIG. 7 is a screen which illustrates step 3 of the 4 steps of FIG. 3. Step 3, refers to recording initial contact with the customer. In other words, the screen of the FIG. 7 is a screen which enables the user to input results of the initial contact into the corresponding open file for this inquiry as at step S110. FIG. 7 provides a list of the results, such as “E-mailed the customer a quote”, “phoned a quote to the customer”, “made a sales visit to the customer”, or that “the customer visited the distributor” or user. Space is provided for other results of the inquiry or additional comments. Once this information has been recorded, it is saved in the server in the specific inquiry file corresponding to that inquiry. In FIG. 7, there is also a selection for a “invalid entry” which can be further seen in FIG. 18. Three of the four steps of FIG. 3 have now been completed. The “submit”, “reset” and “cancel” buttons allow the user to, respectively, record the results, clear original results entry and record corrected results, or cancel the entry results, the latter allowing the inquiry to remain in the “unanswered” category”. The screen at FIG. 8 confirms that the main server has received the input regarding the initial contact with the customer. The screen indicates that the user may return to the main page to respond to additional, unanswered inquiries.

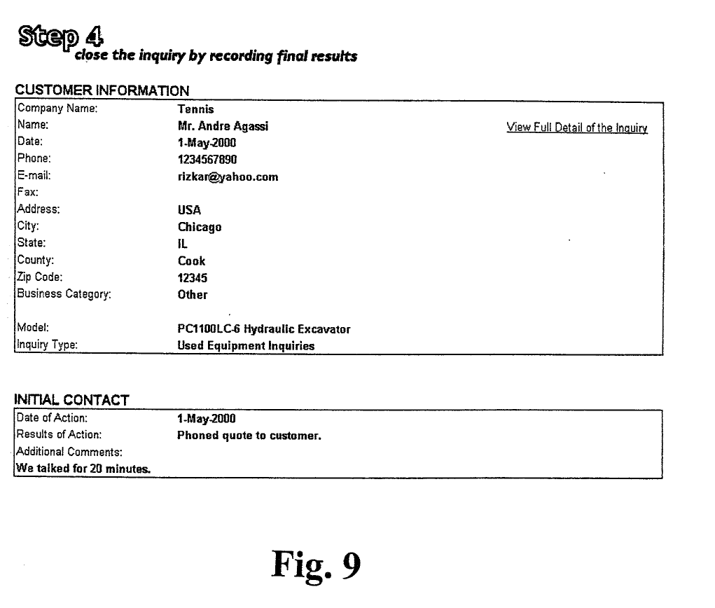

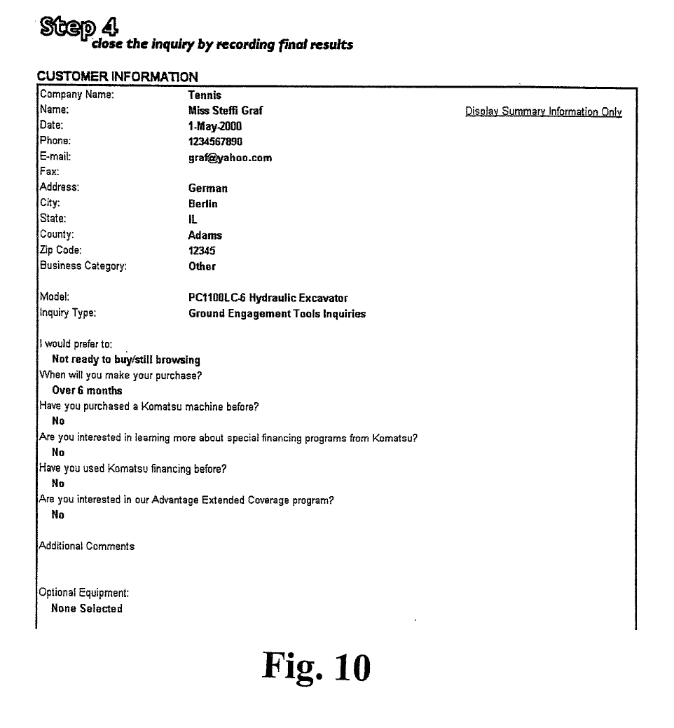

FIG. 9 illustrates the beginning of step 4 of FIG. 3. As at step S112, the user may now put in final results of contact with the customer into the corresponding open inquiry file. Once the initial contact and all subsequent contacts have taken place, then the results may be input in order to close the open inquiry or the open inquiry file. It is important to accurately review all of the existing information in this file as shown in FIG. 9. In FIG. 9, the user may then select “View Full Detail of the Inquiry” to look at the entire original customer inquiry as illustrated in FIG. 10. FIG. 10, of course, is simply an illustration of the entire original customer inquiry, even though the name does not correspond with the name in FIG. 9.

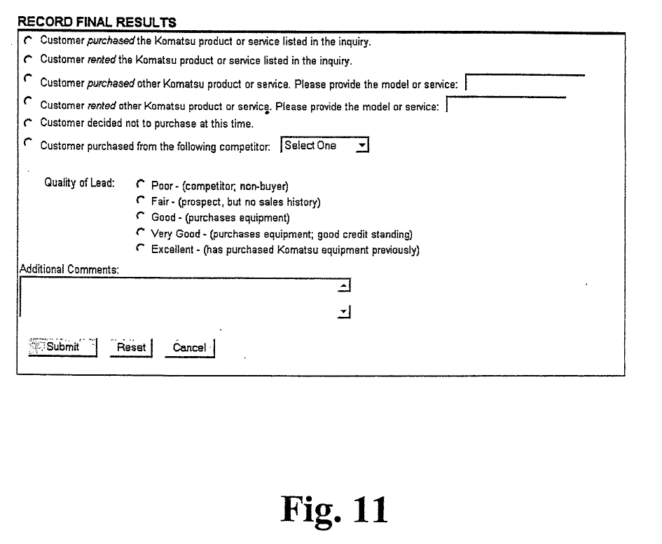

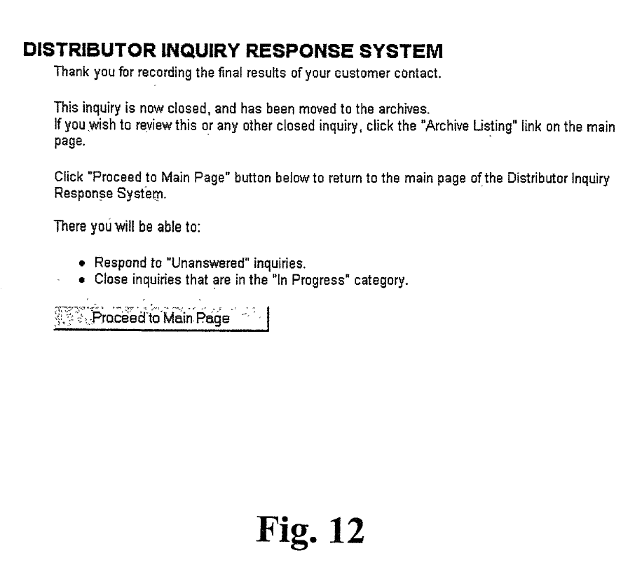

FIG. 11 illustrates a “Final Results” screen. The user may then select the appropriate choice to indicate the results. For example, the user may indicate that the customer “purchased” the product listed in the inquiry, or that the customer “rented” the product listed in the inquiry or “purchased” or “rented” a different product or service than listed in the inquiry, or that the customer did not purchase at all. Additional items are provided in this screen such as, “the customer purchased from a competitor”. A “Quality of Lead” selection from poor to excellent is also provided. Of course, there is a window provided for additional comments which may be pertinent. Once this screen is filled in, the user may select “submit”, “reset”, or “cancel” at the end of the screen to respectively submit the entry to the system and close the open file (step S114), reset the screen and start over, or cancel the entry and maintain the inquiry in the “In Progress” category. FIG. 12 illustrates the confirmation screen thanking the user for recording the final results of the distributor (user)-customer contact. As indicated, the inquiry is then closed and will be moved to the archives section.

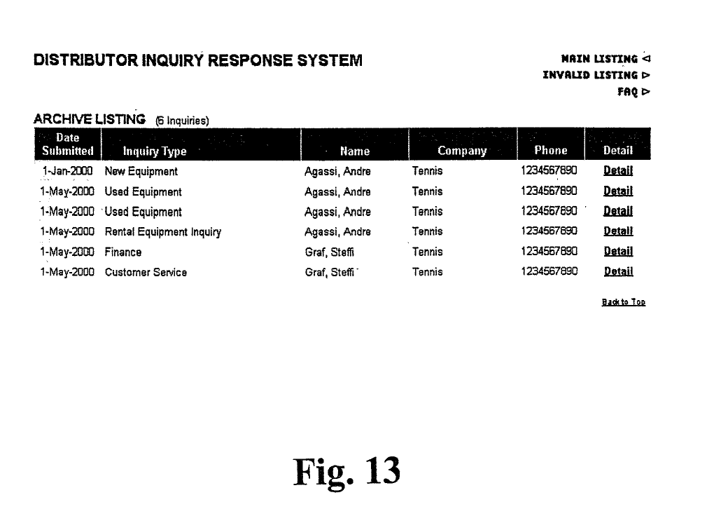

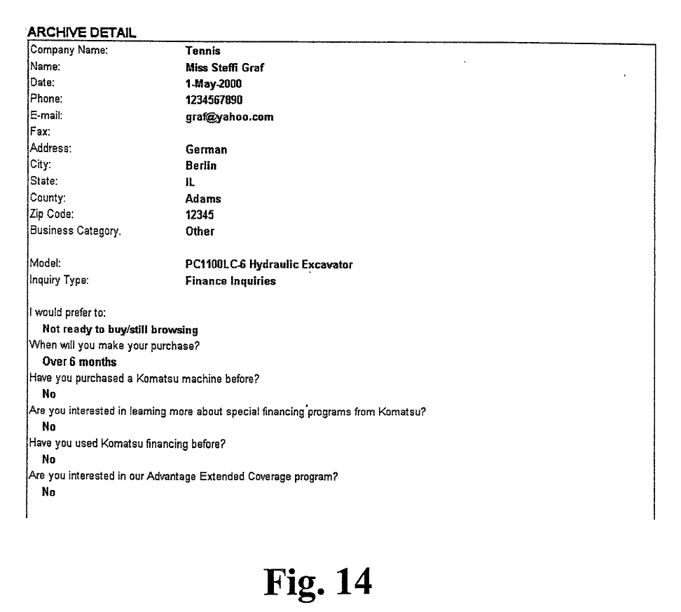

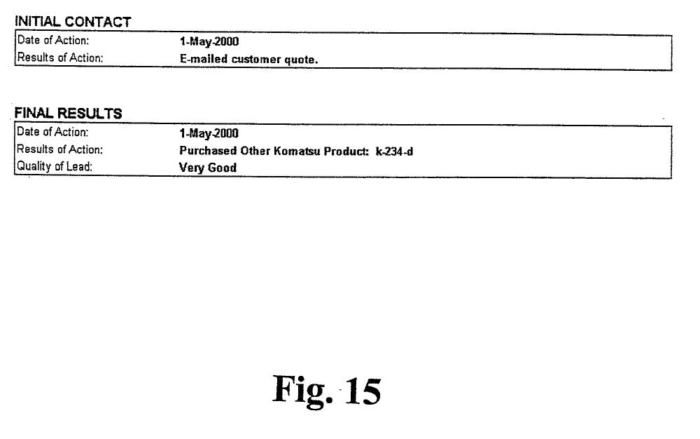

FIGS. 13, 14, and 15 are screens illustrating when the user has selected the “Archive” listing. Specifically, FIG. 13 illustrates a typical archive listing summary. As illustrated, the fields are similar to those in the original “unanswered inquiry” listing. In other words, it includes date submitted, inquiry types, name, company, phone, and a field for additional details. Upon selecting the “detail” column of the desired inquiry, a more detailed screen may be provided as in FIG. 14 and FIG. 15. FIG. 14 illustrates the general inquiry information and FIG. 15 illustrates the results of the initial contact, and the final results.

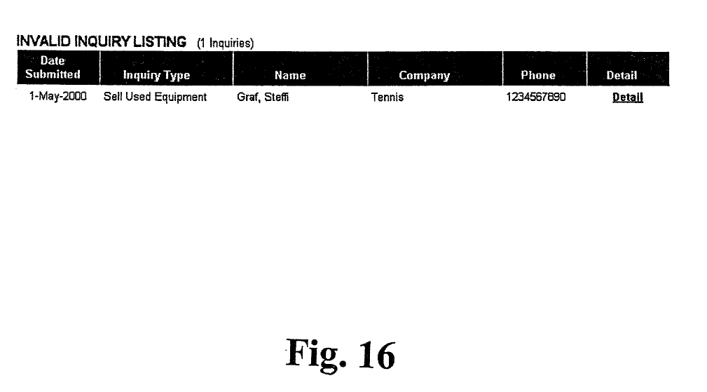

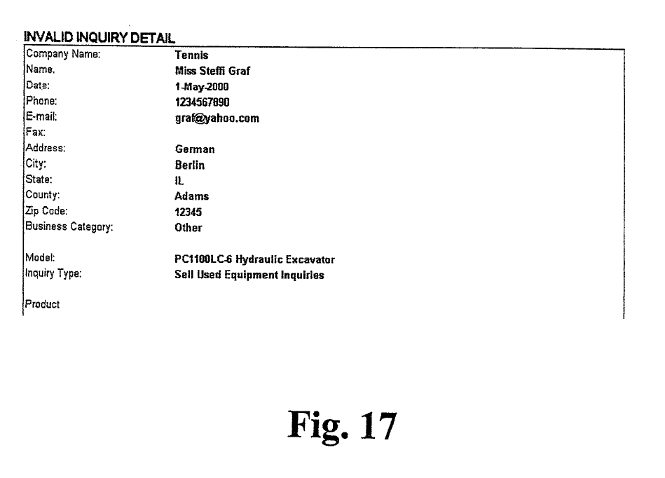

FIGS. 16, 17 and 18 illustrate screens when selecting an “invalid” inquiry listing. FIG. 16 illustrates a typical archive listing summary. In the case of FIG. 16, only one invalid inquiry is listed. As with the other archive listings, the fields are the same. By selecting “detail” in FIG. 16, it is possible to view the full record including the general inquiry information in FIG. 17 and the following comments in FIG. 18 indicating why it is an invalid inquiry.

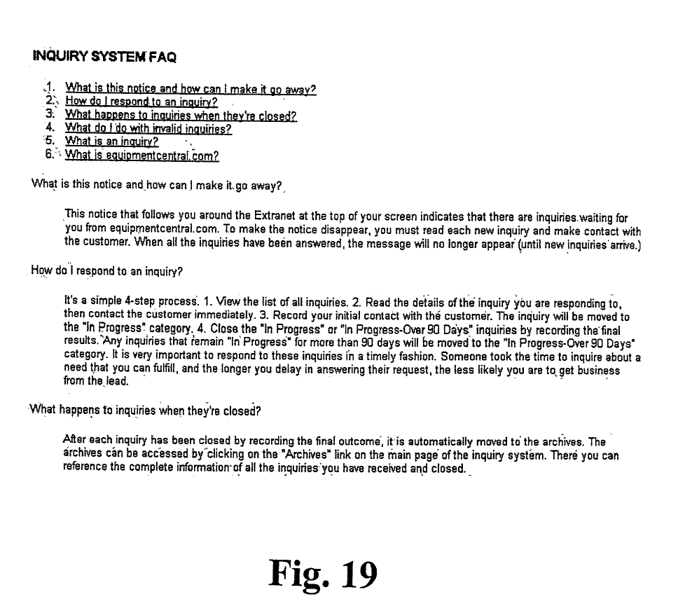

FIG. 19 illustrates an additional screen which may be easily accessed from many screens, including the main screen of FIG. 3. FIG. 19 lists frequently asked questions and their answers, which will help the user more efficiently use the system and method in accordance with the instant invention.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

I claim:

1. A computer based method, in a system wherein a plurality of predetermined users, each having a predetermined sales region and each having access to a secured portion of a main server, for enhancing each user's ability to rapidly respond to internet based inquiries regarding construction machinery and earth moving equipment, comprising the steps of:
receiving, at an internet web site of the main server, a plurality of customer inquiries, said inquiries each including information about the customer;
opening an inquiry file on each received, unanswered inquiry, each inquiry file including said customer information;
sorting each inquiry file into one of a plurality of predetermined regions corresponding to sales regions of the users, wherein the sorting is based upon said customer information;
providing an individual user, who has accessed the secured portion of the main server, with a list of all open inquiry files with unanswered inquiries in that user's region;
upon said user's selection of a single inquiry file from said list, providing said user with said selected inquiry file, including said customer information, so that said user may contact said customer regarding the customer's inquiry;
after said user has initial contact with said customer, enabling said user to input into said secured portion of said main server results of the initial contact; and
enabling said user to input final results of subsequent contact with said customer; and closing said inquiry file after receiving input of said final results.

2. The method of claim 1, further comprising, archiving said inquiry file after said closing step.

3. The method of claim 1, wherein, after input of results of the initial contact, providing said user with the list of remaining unanswered inquiries in open files, so that said user may make another selection.

4. The method of claim 1, wherein said customer information includes at least one of name, address, telephone number and area of interest.

5. The method of claim 4, wherein said customer information also includes, facsimile number, E-mail address, and contact person.

6. The method of claim 1, wherein said step of enabling said user to input said final results includes providing said user with a selection of at least, purchased product or service listed in inquiry, rented product or service listed in inquiry, purchased other product or service, rented other product or service, decided not to purchase, and purchased competitor's product.

7. The method of claim 1, wherein the secured portion of the main server is an extranet web site accessible through the internet.

8. The method of claim 1, wherein the step of providing the individual user with a list of unanswered inquiries of said open files includes, identifying said user as one of said predetermined users upon said user's access to the secured portion of the main server, and preparing said list of unanswered inquiries based on customers located within said user's region.

9. The method of claim 1, further comprising, designating an open inquiry file as answered, once and initial contact is made between the user and customer and the user has input said results of the initial contact.
